(19) United States
(12) Patent Application Publication
(10) Pub. No.: US 2024/0388553 A1
(43) Pub. Date: Nov. 21, 2024

(54) ASYNCHRONOUS AUDIO-BASED COMMUNICATION SYSTEM AND METHOD

(71) Applicant: Woosh Incorporated, Los Angeles, CA (US)

(72) Inventors: Brian Norgard, Los Angeles, CA (US); Naval Ravikant, Los Angeles, CA (US)

(73) Assignee: Woosh Incorporated, Los Angeles, CA (US)

(21) Appl. No.: 18/529,603

(22) Filed: Dec. 5, 2023

Related U.S. Application Data
(60) Provisional application No. 63/467,242, filed on May 17, 2023.
(60) Provisional application No. 63/467,111, filed on May 17, 2023.

(51) Int. Cl. H04L 51/216; H04L 51/10

(52) U.S. Cl. CPC H04L 51/216; H04L 51/10

(57) ABSTRACT

In variants, an asynchronous audio-based communication system can include: one or more messages, one or more conversations, one or more rooms, optionally one or more models, one or more computing systems, and optionally one or more databases. However, the system can additionally and/or alternatively include any other suitable components.

### CROSS-REFERENCE TO RELATED APPLICATIONS

This application claims the benefit of U.S. Provisional Application No. 63/467,242 filed 17 May 2023 and U.S. Provisional Application No. 63/467,111 filed 17 May 2023, each of which is incorporated in its entirety by this reference.

### TECHNICAL FIELD

This invention relates generally to the communications field, and more specifically to a new and useful system and method for communications in the communications field.

### BRIEF DESCRIPTION OF THE FIGURES

FIG. 1 is a schematic representation of a variant of a conversation with a set of messages.

FIG. 2 is a schematic representation of an example of asynchronously-recorded messages (e.g., audio and/or video messages).

FIG. 3 is a schematic representation of an example of parent message dependencies.

FIG. 4 is a schematic representation of an example of establishing parent message dependencies.

FIG. 5 is schematic representation of an example of stitching a message into an adoptive conversation, preserving the parent message dependency for the stitched message, and conversation playback visualization.

FIG. 6 is a schematic representation of an example of a room with a primary and secondary conversation, secondary message parent dependencies on primary messages, and message stitching from the secondary conversation into the primary conversation.

FIG. 7 is a schematic representation of a variant of the communication system.

FIG. 8 is an illustrative example of a conversation representation.

FIG. 9 is an illustrative example of an interface for the system.

FIG. 10 is an illustrative example of a message summary that is automatically generated based on the messages.

FIG. 11 is an illustrative example of recording a message and reviewing the message before posting to the conversation.

FIG. 12 is an illustrative example of clipping messages from a conversation into a clipped conversation and reviewing the clipped conversation before posting.

FIG. 13 is an illustrative example of clipped conversations.

FIG. 14 is a schematic representation of an example of clipping messages from a first and second conversation into a clipped conversation.

FIG. 15 is a schematic representation of the method.

FIG. 16 is an illustrative example of determining a first clipped conversation based on a first and second conversation in a first room, determining a second room based on the clipped conversation, and determining a second clipped conversation based on a third conversation in the second room.

### DETAILED DESCRIPTION

The following description of the embodiments of the invention is not intended to limit the invention to these embodiments, but rather to enable any person skilled in the art to make and use this invention.

### 1. Overview

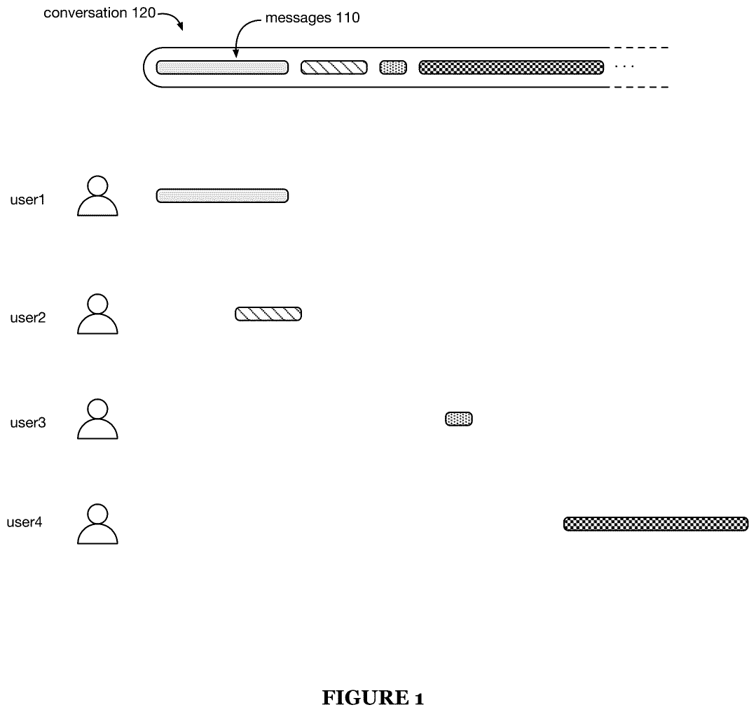

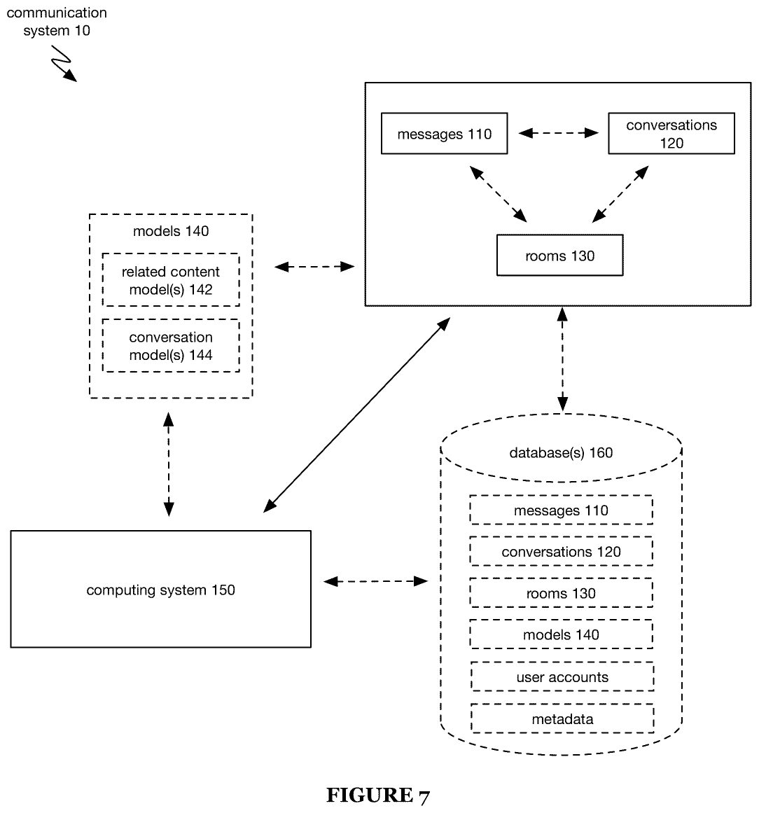

As shown in FIG. 7, the communication system 10 can include: one or more messages 110, one or more conversations 120, one or more rooms 130, optionally one or more models 140, one or more computing systems 150, optionally one or more databases 160, and/or other components. However, the system can additionally and/or alternatively include any other suitable components. In variants, the communication system 10 can include a set of messages 100, organized into one or more conversations 200; example shown in FIG. 1. In examples, the communication system 10 can include a set of audio and/or video messages 100 (e.g., “chits”, “snippets”, “posts”, “voice notes”, etc.) that are combined together into a continuous audio and/or video conversation 120 (e.g., “chitline”).

The communication system 10 functions to enable asynchronous conversation. The asynchronous conversations is preferably an audio-based conversation, but can additionally or alternatively be a video-based conversation, text-based conversation, extended reality conversation (e.g., augmented reality conversation, virtual reality conversation, etc.), and/or include any other suitable set of communication modalities.

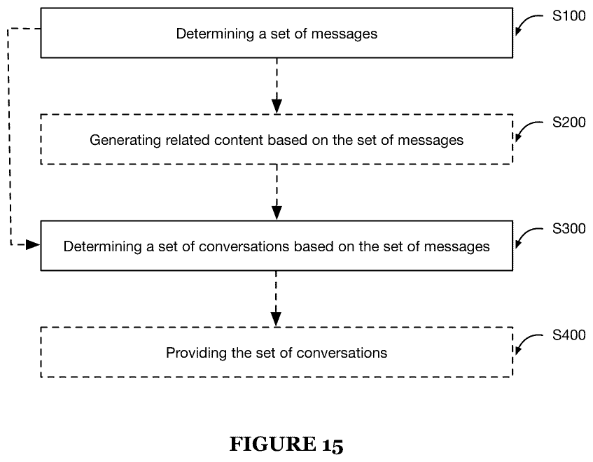

As shown in FIG. 15, the method can include: determining a set of messages S100, optionally generating related content based on the set of messages S200, determining a set of conversations based on the set of messages S300, and optionally providing the set of conversations S400. However, the method can additionally and/or alternatively include any other suitable elements.

The method functions to determine a set of conversations 120 (e.g., original conversations, adoptive conversations, clipped conversations, etc.) based on a set of messages 110.

One or more variations of the system and/or method can omit one or more of the above elements and/or include a plurality of one or more of the above elements in any suitable order and/or arrangement.

### 2. Examples

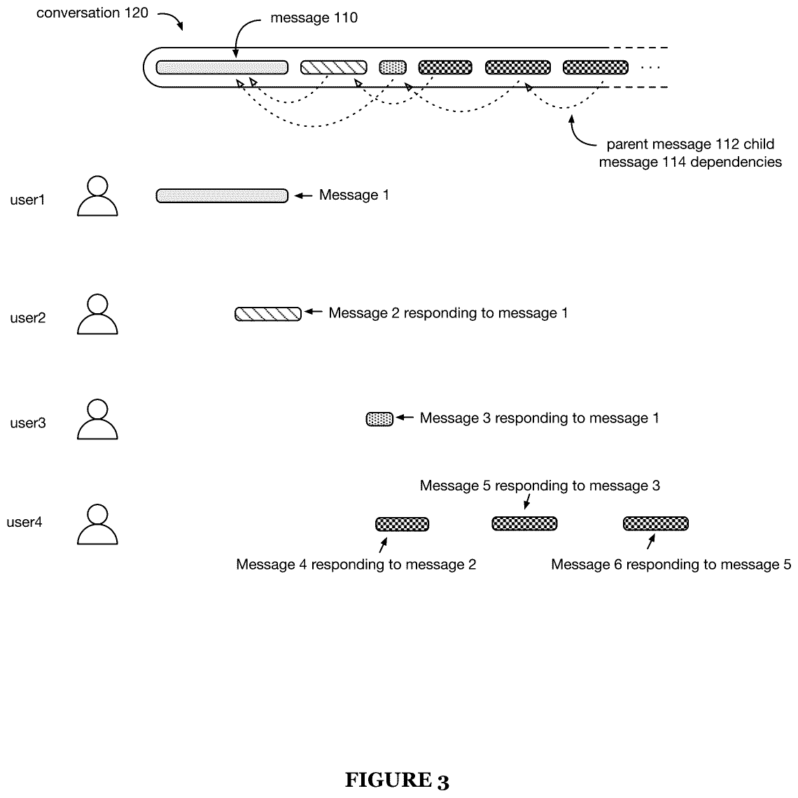

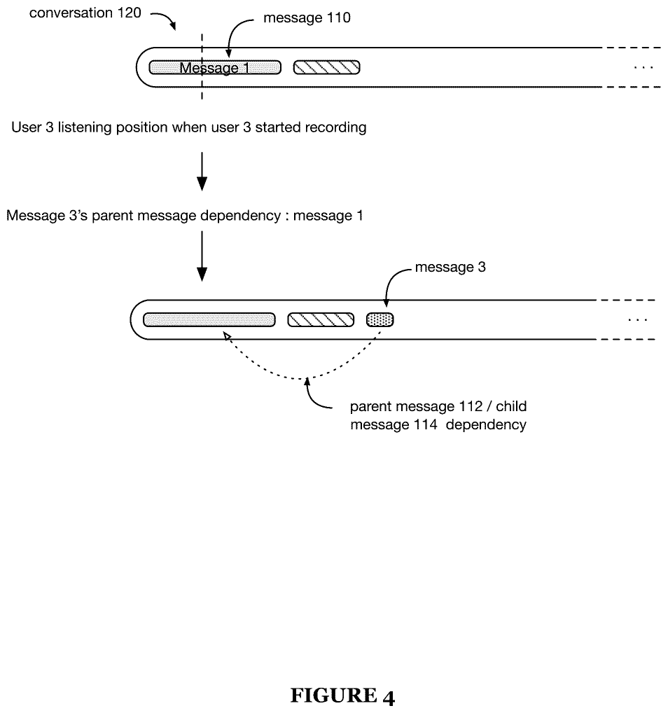

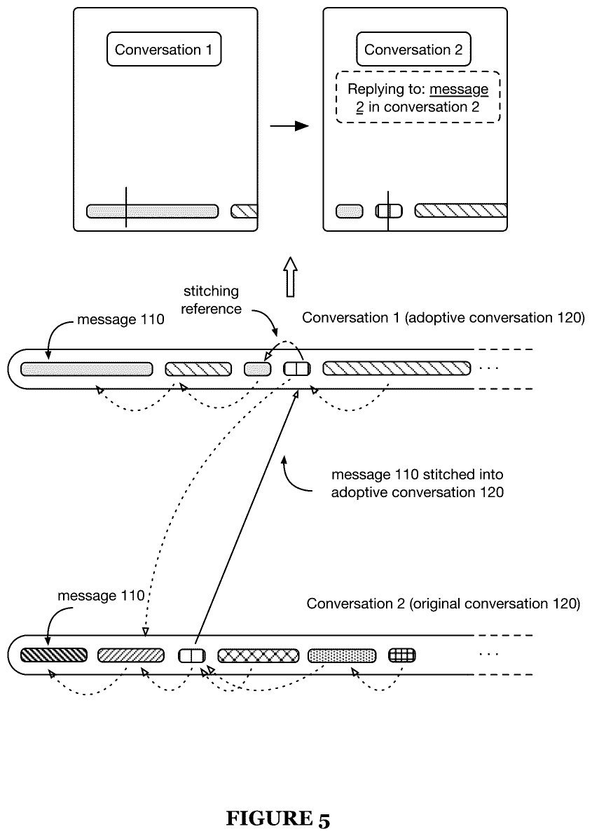

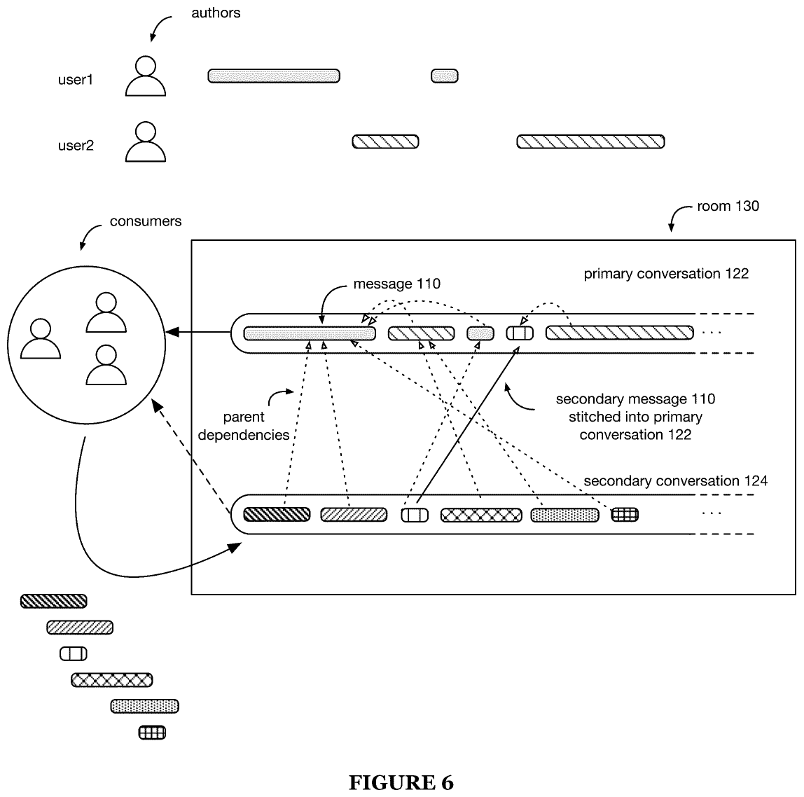

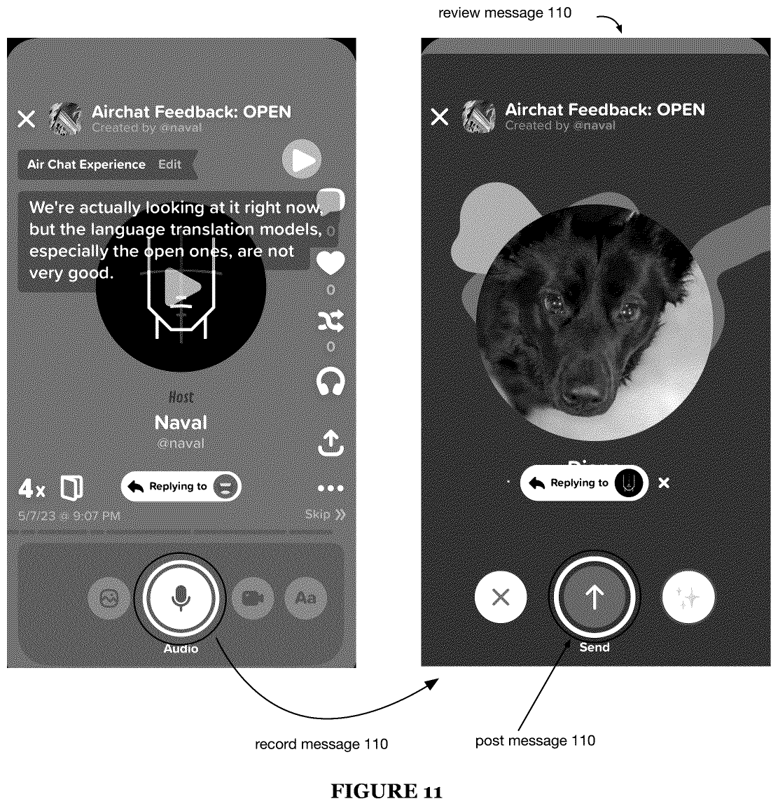

In an illustrative example, the communication system can include a set of audio and/or video messages (“chits”; “A/V messages”, “audio/video messages”) that are combined together into a continuous conversation (“chitline”), example shown in FIG. 1. A conversation can include a series of nonoverlapping A/V messages, wherein a user can navigate through the series of A/V messages (e.g., skip an A/V message, replay an A/V message, etc.). Each A/V message in the conversation can be recorded asynchronously (e.g., not contemporaneously, not concurrently, not in real-time, when the authors are not in the same virtual room (“chat”) at the same time, etc.). In examples, an asynchronous A/V message can be recorded: asynchronously from parent message recording; while the parent message's author is offline or is not actively participating in the conversation; be an A/V message that is not recorded in real-time; and/or be recorded at any other suitable time or with any other suitable relationship to the other messages in the conversation. Each A/V message can be atomic (e.g., not editable after posting), be editable by the author, be editable by other users, and/or be otherwise editable or noneditable. Each A/V message can be associated with a parent message (e.g., a single parent message, multiple parent messages, etc.), wherein the A/V message is considered a reply to the parent message (e.g., can link back to the parent message) (e.g., examples shown in FIG. 3, FIG. 4, FIG. 5, FIG. 6, and FIG. 11). The parent message is preferably the message that was playing when the A/V message author recorded the A/V message (e.g., when the A/V message author pressed “record”), but can additionally or alternatively be the message that finished playing within a predetermined time period before the A/V message was recorded (e.g., immediately before A/V message recording, within 5 seconds of A/V message recording, etc.); be a message specified as a parent message by the A/V message author; be the last message in the conversation; and/or be any other suitable message. The parent message is preferably part of the same conversation as the A/V message (e.g., originated in the conversation, was stitched into the conversation, etc.), but can additionally or alternatively be part of a separate conversation. In examples, this parent-child dependency can provide context for the A/V message, and can be navigated (e.g., by A/V message consumers), summarized, represented as a data structure (e.g., a graph, an array with dependencies, etc.) for subsequent analysis, or otherwise used. The recorded A/V message can be appended to the end of the parent message's conversation, not added to the conversation, or otherwise associated with the conversation.

Each A/V message can be stitched (e.g., “remixed”, “threaded”, etc.) or added into other conversations (e.g., adoptive conversations) that are different from the original conversation, wherein the stitched A/V message can refer back to the original conversation and/or the respective parent message (e.g., examples shown in FIG. 5 and FIG. 6), and/or otherwise preserve the stitched A/V message metadata.

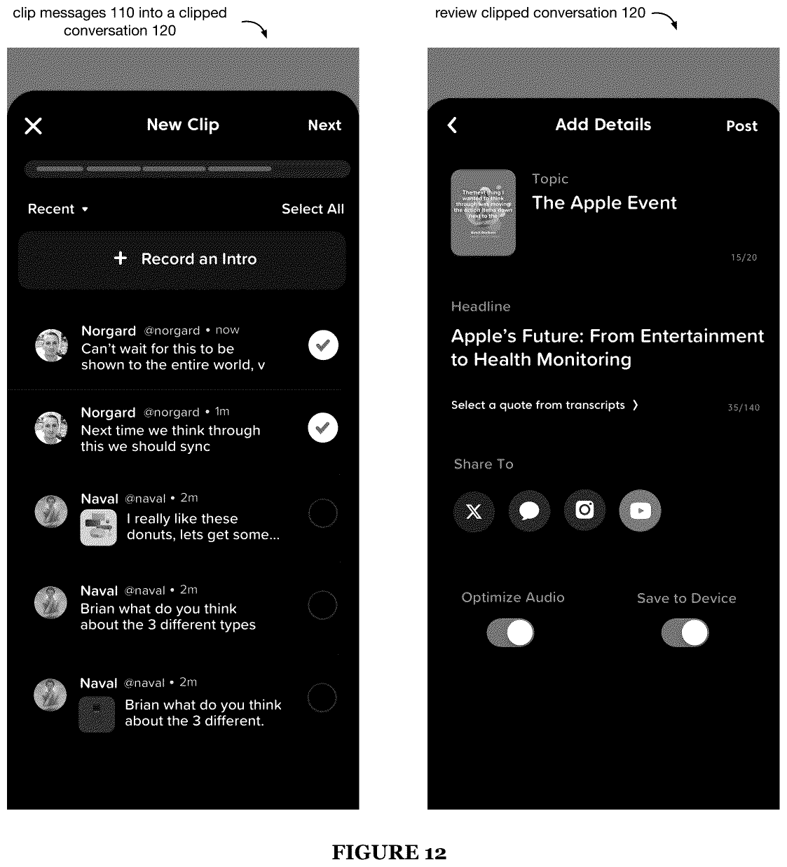

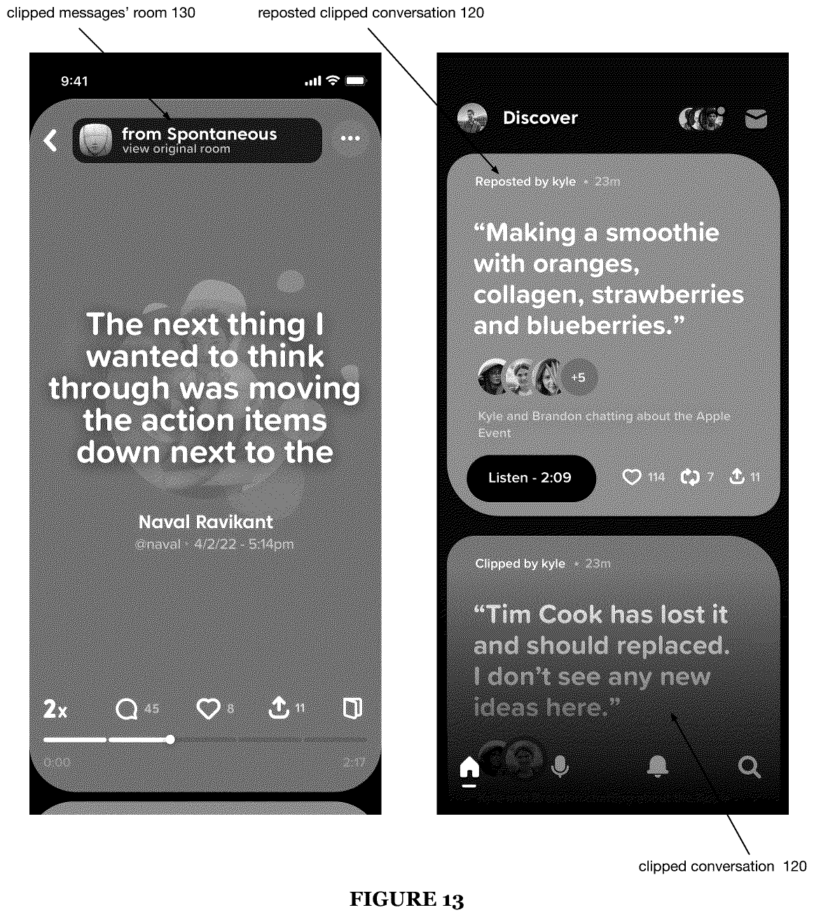

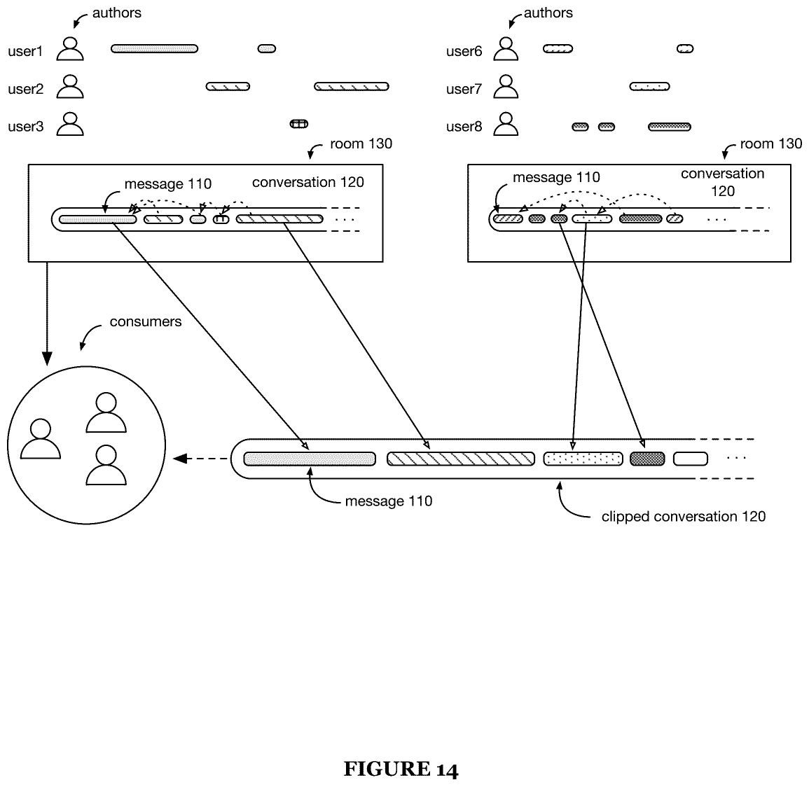

Additionally or alternatively, multiple A/V messages from one or more conversations (e.g., from one or more rooms) can be clipped together (e.g., manually) into a clipped conversation (e.g., “clips”, examples shown in FIG. 12, FIG. 13, and FIG. 14). The clipped conversation can be published (e.g., on social media and/or other distribution channels), added to a conversation or room, or otherwise used. In this example, the constituent A/V messages within the clipped conversation can be cut, commented upon, mixed, and/or otherwise edited, or be uneditable. In this example, the constituent A/V messages within the clipped conversation can be added in any order, independent of the original A/V message order or dependencies within the original conversation (e.g., example shown in FIG. 14), or be added according to a set of rules (e.g., temporal order, contextual order, parent dependency order, etc.).

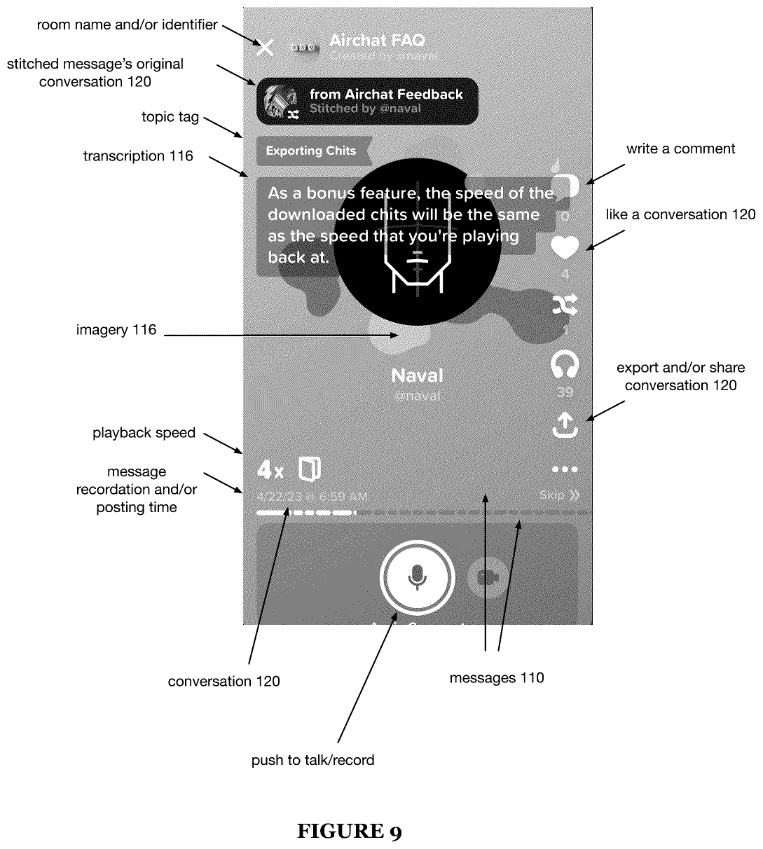

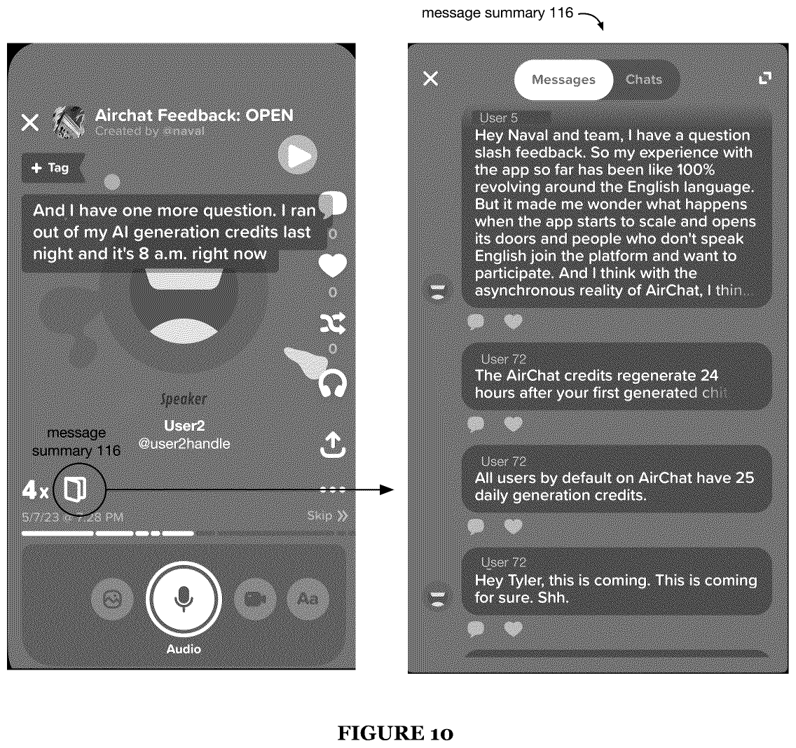

In variants, additional related content in alternative domains can be generated for each A/V message, either automatically (e.g., using machine learning models such as a generative model, etc.) or manually. Examples of related content in alternative domains can include: text transcriptions, translations into other languages (e.g., text or synthesized audio), video, imagery, haptic feedback, and/or other content (e.g., examples shown in FIG. 9, FIG. 10, and FIG. 11). However, the communication system can be otherwise configured.

### 3. Technical Advantages

Variants of the technology can confer one or more advantages over conventional technologies.

First, variants of the technology enable clear audio-based conversations by using asynchronous A/V messages. Conventional audio-based communication platforms are synchronous, which causes authors (contributors) to speak over each other. By using asynchronous A/V messages, this technology enables contemporaneously-generated A/V messages to be threaded after each other (e.g., the playback is serial instead of overlapping) while preserving the context in which the A/V message was generated (e.g., by including a reference to the parent message that the A/V message was responding to). Furthermore, conventional synchronous systems create moderation issues-it is difficult to determine who should be invited into the conversation in real-time. By using asynchronous A/V messages, this technology enables a moderator (e.g., chitline administrator, room administrator, etc.) to select which A/V messages from a user to include in the main conversation, which allows the moderator to selectively include a user without giving the user free access to contribute to the main conversation. Additionally, conventional synchronous systems require all users to be present in a conversation at the same time in order to contribute to the conversation, which can be incompatible with contributors' schedules and contribution styles. By using asynchronous A/V messages, this technology enables contributors to contribute to a conversation at their own pace.

Second, variants of the technology enable conversation threading in a facile, intuitive manner. In variants, the inventors have discovered that appending a response to a prior message—even one early on in the conversation—to the end of the conversation (e.g., in the order that the message was recorded), can be more intuitive than inserting the response mid-conversation (e.g., adjacent the original message), particularly when a user has a reference back to the original message that the current message is responding to.

Third, variants of the technology enable new conversations to be generated by using asynchronous A/V messages. For example, A/V messages from different conversations can be combined together into new conversations or stitched into other conversations. In variants, conversations can be a series of A/V message identifiers (e.g., pointers) that refer back to an A/V message repository or database (e.g., example shown in FIG. 7). These variants can reduce computing resources by not duplicating the A/V message each time it is stitched into another conversation. Additionally, the original context of the stitched A/V messages can be preserved by keeping the A/V messages atomic (e.g., another user cannot splice an A/V message and take the audio snippet out of context) and/or by preserving the original dependencies back to the originating conversation and/or parent message.

Fourth, variants of the technology enable on-the-fly creation and/or sharing of clipped conversations (e.g., “highlights”, “clips”, “micro-podcast”, etc.). For example, individual A/V messages can be selected from conversations that share the same room, and copies of the A/V messages (or pointers to the A/V messages) can be assembled (e.g., based on recordation order, posting order, a manually-specified order, etc.) to form a clipped conversation. The clipped conversation can be exported to a user device, to a social media platform, added to a new or pre-existing conversation, added to a room, and/or otherwise distributed. Furthermore, the clipped conversation can be used to launch a new virtual room (e.g., “chat”) that expires after a certain time (e.g., after 24 hours). Individual A/V messages can be selected from conversations in the new virtual room to form a second clipped conversation, and the second clipped conversation can be used to launch a second virtual room. This feedback loop between creating clipped conversations and launching virtual rooms enables contributors to keep conversations moving.

Fifth, variants of the technology enable a “push-to-talk, when you want” paradigm, which can enable more natural interactions (e.g., enable banter, laughter, inflections, etc.) between users.

However, the technology can confer any other suitable benefits.

### 4. System

The method can be performed using a communication system 10 (example shown in FIG. 7), including: one or more messages 110, one or more conversations 120, one or more rooms 130, optionally one or more models 140, one or more computing systems 150, optionally one or more databases 160, and/or any other suitable components. However, the method can additionally and/or alternatively be performed using any other suitable system. The system 10 can function to facilitate execution of the method. However, the system 10 can provide any other suitable functionality.

The system 10 can be used by one or more users, who can function as authors, consumers, administrators, and/or function in other suitable roles. In a first example, a user functions as an author, a consumer, and an administrator. In a second example, a user functions as only a consumer and an administrator. In a third example, a user functions as only an author and a consumer. In a fourth example, a user functions as only a consumer. However, the user can function in any other suitable role(s).

The one or more users can include authors. Authors (e.g., contributors) can create content, such as record messages 110, post messages 110, respond to messages 110, create conversations 120 (e.g., by recording audio), and/or otherwise create content. Additionally and/or alternatively, authors can create skins, related content 116, models 140 (e.g., to automatically generate related content 116, to automatically determine conversations 120, etc.), plugins, extensions, and/or any other suitable modules for the system.

The one or more users can include consumers. Consumers can consume content, such as listen to messages 110 and/or conversations 120 (e.g., a series of one or more messages 110), interact with content (e.g., like a conversation 120, bookmark a conversation 120, subscribe to a conversation 120, like a message 110, bookmark a message 110, subscribe to another user, bookmark a room 130, subscribe to a room 130, write a comment, etc.), save content (e.g., save a conversation 120 to a user device), share content (e.g., export a conversation 120 to a third-party application), format content (e.g., change a file format of a conversation 120), copy and/or paste content (e.g., copy a transcription to a clipboard), and/or otherwise consume content. Additionally and/or alternatively, consumers can create related content 116, models 140, plugins, extensions, and/or any other suitable modules for the system.

The one or more users can include administrators. Administrators can control permissions for different conversations 120, rooms 130, and/or for any other suitable interaction forums. Examples of permissions that can be controlled include: inviting a user to the forum, inviting a user to a conversation tier (e.g., discussed below), muting a user, blocking a user (e.g., the banned user cannot interact with the conversation 120, cannot interact with original messages 110 generated from the conversation 120, etc.), hiding a user (e.g., messages 110 posted by the user cannot be seen by other users viewing the conversation 120), changing the type of user that can access the forum (e.g., changing the social network connection requirements), changing the privacy settings for the forum (e.g., private, public, etc.), and/or any other suitable permissions.

However, the one or more users can be otherwise defined.

Each user can be associated with a user account or not be associated with a user account. Each user can be associated with a user identifier or not be associated with a user identifier. The user identifier can be globally unique, locally unique, nonunique, and/or otherwise unique or nonunique.

The system 10 is preferably used with a user interface, but can alternatively not be used with a user interface. For example, the system 10 is presented to the users on an application (e.g., native application, smartphone application, etc.) executing on a user device (e.g., mobile device, smartphone, smartwatch, etc.). However, the system 10 can be otherwise presented to the users. The user interface can be used to: input and/or output messages 110, output conversations 120, otherwise interact with messages 110 and/or conversations 120, present related content 116, input and/or output other information, present other information, and/or be otherwise used. The user interface can be: a graphic user interface (GUI), a command line interface, an application programming interface (API), and/or any other suitable type of interface. The user interface can be an application (e.g., web application, native application, smartphone application, etc.) on a user device (e.g., mobile device, smartphone, smartwatch, tablet, laptop, desktop, etc.), an API, and/or any other suitable interface. However, the user interface can be otherwise configured.

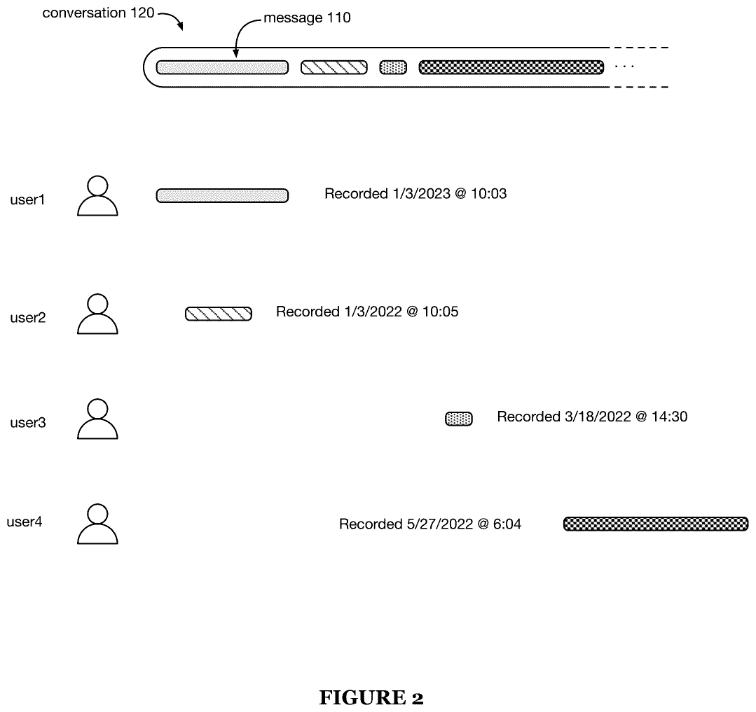

The system 10 can include one or more messages 110 (e.g., “chits”), which can function as communication units. The messages 110 are preferably asynchronous (e.g., not contemporaneously; not concurrently; not real-time; example shown in FIG. 2; etc.), but can additionally and/or alternatively be synchronous, contemporaneous, concurrent, real-time, and/or otherwise temporally defined. A message 110 can be considered asynchronous when it is recorded: while one or more other users in the conversation 120 and/or the room 130 are offline; while one or more other users in the conversation 120 and/or room 130 are not actively participating in the conversation 120 (e.g., not logged into the conversation 120, not logged into the conversation's room 130, doesn't have the conversation 120 open on their device, etc.); after a threshold amount of time from prior message (e.g., parent message 112) recording or posting (e.g., 30 seconds, 1 minute, 5 minutes, 10 minutes, 30 minutes, 1 hour, 1 day, etc.); and/or otherwise defined.

The messages 110 are preferably audio messages recorded by a user, but can additionally and/or alternatively include other communication domains, such as text, visuals (e.g., imagery, video, etc.), haptics, and/or any other suitable domains. In a first example, the messages 110 are audio messages (e.g., audio-only messages). In a second example, the messages 110 are audio-video messages (e.g., include both audio and video). However, the messages 110 can include any other suitable combination of domains.

The message 110 is preferably atomic (e.g., treated as a singular unit, cannot be split or edited after posting), but can alternatively be nonatomic. In a first variant, an atomic message cannot be edited after posting (e.g., but can be edited or deleted after recording and before posting). Editing can include: deleting, cutting, trimming, adjusting the acoustic background, layering on secondary tracks or other auxiliary content, remixing, adjusting relative volume, adjusting the default playback speed, adjusting the voice or tone, or otherwise adjusting parameters of the audio and/or video message. In a second variant, only the author can edit all or some of the parameters of the atomic message after posting. In a third variant, authorized users (e.g., the author of the message, a room or conversation administrator, a user authorized by the author, etc.) can edit all or a limited set of the message parameters. However, atomic messages can be otherwise editable or non editable.

The message 110 can be persistent or non-persistent (e.g., temporary; be deleted from the system 10 and/or database 160 or unavailable after a threshold amount of time, such as 30 minutes, 1 hour, 1 day, 1 week, 1 month, etc.). The message 110 can have an unlimited duration, a limited duration (e.g., be limited to 30 seconds, 1 minute, 5 minutes, 10 minutes, 30 minutes, 1 hour, etc.), and/or any other suitable duration.

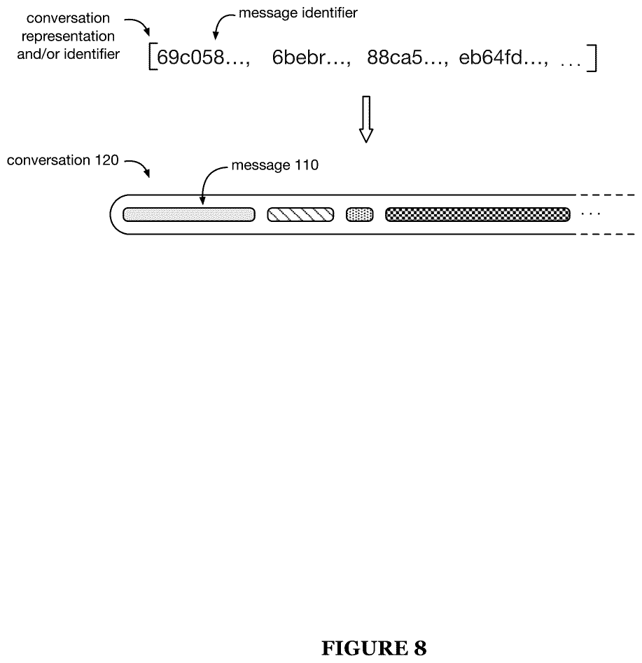

The message 110 can be associated with a message identifier or not be associated with a message identifier. Each message 110 is preferably associated with a single message identifier in the platform, but can additionally or alternatively be associated with multiple message identifiers (e.g., one for each conversation that the message 110 is included within, one for each version of the message 110, etc.). The message identifier can function as a pointer, and enable the message 110 to be used in secondary conversations 124 that were not the original and/or primary conversation 122 that the message 110 was authored within. Additionally and/or alternatively, the message identifier can be otherwise used. The message identifier can be generated based on: recording time (e.g., recording timestamp, recording time frame, etc.), posting time (e.g., posting timestamp), user identifier, conversation identifier, room identifier, message content, message generation order, topic (e.g., topic tag), and/or any other suitable information. The message identifier can be a hash (e.g., example shown in FIG. 8), a concatenation of information, a string, and/or otherwise constructed. The message identifier is preferably globally unique, but can additionally and/or alternatively be locally unique (e.g., within the conversation 110), nonunique, and/or otherwise unique or nonunique. The message identifier for each message 110 is preferably automatically determined (e.g., based on a hash of the message content, message audio, message text, message metadata, a random nonce, etc.; incremented; etc.), but can additionally and/or alternatively be manually determined, semi-automatically determined, and/or otherwise determined.

The message 110 can be associated with one or more pieces of metadata or not be associated with metadata. Examples of metadata associated with a message 110 can include: message author (e.g., the user that recorded the message 110, user identifier of the author, etc.), message's number of interactions (e.g., views, listens, etc.), message's number of likes, message's number of comments, message's number of replies, message's parent message 112 (e.g., the prior message that the message 110 is responding to), message's original conversation and/or primary conversation 122 (e.g., that the message 110 was authored within), recording time of the message 110 (e.g., recording timestamp, recording time frame, etc.), timestamp at which the message 110 was added to a conversation 120 (e.g., posting timestamp, stitching timestamp, clipping timestamp, etc.), message recording geolocation, message duration, message size (e.g., file size), topic tags (e.g., manually assigned or automatically generated from the message content), content encodings (e.g., feature vectors, generated using an encoder or layers of a neural network model from the message content), and/or any other suitable metadata.

The message 110 can be associated with permissions or not be associated with permissions. Examples of permissions include: privacy settings (e.g., private message, public message, a list of users who can have access to the message 110, a list of users to hide the message 110 from, etc.), and/or any other suitable type of permissions. Different privacy settings can result in different consumer access (e.g., only authorized users can access private messages, all users can access public messages, etc.), different processing settings (e.g., private messages are limited to local processing), stitching settings (e.g., private messages cannot be stitched into other conversations 120, can only be stitched into conversations 120 with the same permissions and/or accessibility, or will not appear to unauthorized users in other conversations 120, etc.), clipping settings (e.g., private messages cannot be clipped together from a conversation 120), and/or result in any other different interactions.

The message 110 can be associated with a parent message 112, which can be a prior message (e.g., in a conversation 120) that the message 110 was responding to, or be otherwise defined. Additionally or alternatively, the message 110 can be unassociated with a parent message 112 (e.g., be the beginning of a conversation 120, be a random thought loosely connected to the conversation 120, etc.). Each message 110 is preferably associated with a single parent message 112, but can alternatively be associated with multiple parent messages 112 (e.g., one parent message 112 per conversation 120, multiple parent messages 112 per conversation 120, etc.). The parent message 112 is preferably automatically determined, but can additionally and/or alternatively be manually determined, and/or otherwise determined.

In a first variant, the parent message 112 is the message 110 that the user was listening to when the user started recording the current message 110 (e.g., examples shown in FIG. 4 and FIG. 11).

In a second variant, the parent message 112 is the message 110 that the user assigns as the parent message 112 (e.g., example shown in FIG. 11).

In a third variant, the parent message 112 is the message 110 preceding the current message 110 in the conversation 120 (e.g., the last message in the conversation 120 before the current message is added to the conversation).

In a fourth variant, the parent message 112 is automatically selected from the prior messages in the conversation 120 based on the current message's content. In an example, a parent message 112 can be assigned based on a similarity or distance score, such as a cosine score, between the parent message and current message's content encodings.

In a fifth variant, the parent message 112 is the message 110 that the user was listening to within a predetermined duration before current message 110 recording (e.g., the message that was played back 1 second, 5 seconds, 10 seconds, 20 seconds, 30 seconds, or another duration before current message recording, etc.).

However, the parent message 112 can be otherwise determined.

The message 110 can be associated with one or more stitching references or not be associated with stitching references. The stitching reference can function to specify the order and/or relevancy of the message 110 to a prior message in an adoptive conversation (e.g., example shown in FIG. 5). An adoptive conversation can be a conversation 120 (e.g., series of messages 110) that the message 110 was not originally posted within, but is subsequently added to after posting to the original conversation (“originating conversation”). Additionally or alternatively, the adoptive conversation can be a new conversation (e.g., clipped conversation) formed partially or wholly from messages 110 posted in other conversations. For example, the adoptive conversation can be a clipped conversation formed from messages from one or more originating conversations (referenced messages) and/or messages recorded by the clipped conversation author (authored clip messages). In specific examples, the referenced messages can remain atomic (e.g., cannot be cut or trimmed), but certain parameters (e.g., background music, mixing volume, background noise, etc.) can be editable, while authored clip messages can be editable (e.g., cut, trimmed, deleted, etc.); alternatively, the messages 110 within the clipped conversation can be otherwise editable or uneditable. Additionally and/or alternatively, the adoptive conversation can be otherwise defined. The adoptive conversation and the original conversation are preferably in different rooms 130, but can additionally and/or alternatively be in the same room 130. A stitching reference can reference a message 110 in the adoptive conversation, wherein the referenced message 110 can be an original message (e.g., originally posted in the adoptive conversation) or be a stitched message (e.g., not originally posted in the adoptive conversation, a copy of the message 110 from the original conversation, etc.). However, the stitching reference can reference any other suitable message 110 and/or be otherwise used. The stitching reference can be: manually assigned (e.g., based on the order that the messages 110 were manually stitched into to the adoptive conversation, based on the order in which a user dragged-and-dropped the messages 110 into the adoptive conversation, based on an order number assigned to the message 110, etc.); automatically assigned (e.g., based on the message addition order to the adoptive conversation, based on content similarity, based on recordation and/or posting timestamp, etc.); and/or otherwise determined.

Additionally and/or alternatively, the message 110 can be associated with one or more child messages 114 or not be associated with child messages 114. A child message 114 can: reference the current message 110 as a parent message 112; reference the current message 110 using a stitching reference; and/or be otherwise defined. A child message 114 is preferably automatically determined (e.g., during child message creation), but can additionally and/or alternatively be manually determined (e.g., manually specified by a user), and/or otherwise determined.

The message 110 can include auxiliary, related content 116 (e.g., examples shown in FIG. 9, FIG. 10, and FIG. 11) or not include related content 116. The related content 116 can be: a transcription, a translation into another language (e.g., text or synthesized speech), imagery, audio, video, haptic feedback, and/or in any other suitable domain. The related content 116 can be presented (e.g., played back, displayed on a user interface, etc.) concurrently with message playback (e.g., overlaid over the audio/video message 110), be presented asynchronously from message playback (e.g., as a text summary of the conversation 120, etc.), be used for downstream processing (e.g., translation, etc.), searched (e.g., using a text based search), and/or otherwise used. The related content 116 can be automatically determined (e.g., generated using a related content model 142), manually determined, and/or otherwise determined. However, the related content 116 can be otherwise configured.

The message 110 can enable a set of interactions, including: recording the message 110 (e.g., by pressing and holding a record button during recording; during a continuous button press; by tapping the button to start recording and tapping the button again to stop recording; etc.; example shown in FIG. 11), reviewing the message 110 (e.g., playing the message back prior to posting, etc.; example shown in FIG. 11), editing the message 110 (e.g., allowing the user to re-record the message 110, edit the transcript, edit the parent message dependency, edit tags, etc. prior to publishing), post-processing the message 110 (e.g., automatically adding related content 116, removing noise, removing filler words such as “um”, “uh”, and/or “like”, optimizing the audio of the message 110, optimizing the video resolution of the message 110, etc.), playing back the message 110 (e.g., presenting the audio, optionally concurrently with the respective related content 116; playing back the message 110 at varying speeds, such as 1×, 2×, 3×, 4×, or 5× the original speed; playing back the message 110 in a different language, such as the consumer's native language and/or a default language; etc.), posting the message 110, stitching the message 110 into a conversation 120 (e.g., stitching the message into an adoptive conversation, etc.), clipping the message 110 from the conversation 120 into a clipped conversation 120, skipping the message 110, saving the message 110 (e.g., saving the message 110 to a user device), and/or any other suitable interactions.

However, the one or more messages 110 can be otherwise configured.

The system 10 can include one or more conversations 120 (e.g., “chitlines”), which can function as a collection of messages 110 that cooperatively form a set of interactions between users (e.g., example shown in FIG. 1).

A conversation 120 can include one or more messages 110 (e.g., asynchronous audio messages that are combined together into a unified, continuous audio stream). The messages 110 can be recorded in the same conversation 120, recorded in a different conversation 120 (e.g., manually stitched into this conversation), be a message placeholder, recorded in the same room 130, recorded in different rooms 130, and/or be any other suitable message.

In variants, during conversation playback, the message placeholder can be dynamically replaced with a message 110 (and/or an identifier for the message), which can enable different users to hear personalized messages 110 during the message placeholder timeslot in the conversation 120. In an illustrative example, the conversation 120 can include a series of messages 110 that collectively form a podcast, wherein the message placeholders can point to personalized advertisements for each of the listeners. During playback, the personalized advertisement can be retrieved (e.g., from a database 160) and played when the message placeholder is encountered in the conversation 120.

The messages 110 within a conversation 120 are preferably arranged in a series of nonoverlapping, adjoining messages 110 (e.g., multiple messages 110 do not concurrently play back), but can additionally and/or alternatively overlap (e.g., multiple messages 110 can concurrently play back), and/or be otherwise arranged. The messages 110 within a conversation 120 are preferably organized in recordation and/or posting order (e.g., with the new messages 110 appended to the end of the conversation 120; examples shown in FIG. 1, FIG. 2, FIG. 3, and FIG. 4), but can additionally and/or alternatively be organized in dependency order (e.g., wherein response messages 110 are arranged proximal their parent messages 112 or their stitching references), manually organized, organized based on message content similarity, organized according to a set of rules or heuristics, organized by a neural network, randomly organized, and/or otherwise organized.

The message order within a conversation 120 is preferably the same for all listeners, but can additionally and/or alternatively vary based on listener preference, when the listener started listening to the conversation 120, and/or otherwise vary. For example, a new message 110 can be appended to the end of the conversation 120 if a listener has already passed the parent message 112, but can be appended after the parent message 112 if the listener has not already passed the parent message 112. However, the message order can be otherwise determined.

The message 110 preferably appears in a conversation 120 once, but can additionally and/or alternatively appear in a conversation 120 multiple times (e.g., include a single parent message 112 and multiple stitching references to other messages 110 in the same conversation 120), and/or appear in a conversation 120 any other suitable number of times.

The conversation 120 can be represented as: a series of message identifiers (e.g., example shown in FIG. 8), a series of pointers to messages 110, a graph (e.g., with parent message dependencies and/or recordation time dependencies), and/or otherwise represented.

The conversation 120 can be associated with one or more users (e.g., administrators; example shown in FIG. 9) or not be associated with users. The users can control conversation permissions (e.g., privacy settings, user access settings, etc.), author messages 110 within the conversation 120, add messages 110 to the conversation 120 (e.g., stitch messages 110 from other conversations 120 into the conversation 120, clip messages 110 together from other conversations 120 into the conversation 120, etc.), reorder messages 110 within the conversation 120, assign users to different conversation tiers within a given room 130, hide messages 110 within the conversation 120, skip messages 110 within the conversation 120, report messages 110 within the conversation 120, hide messages 110 within the conversation 120, and/or otherwise control conversation interaction.

For example, the admin can control whether a conversation 120 is private or public. Private conversations 120 can have end-to-end encryption, communicate using peer-to-peer protocols (e.g., WebRTC), require user authentication, be limited to local processing, and/or have any other suitable other protections, while public conversations 120 can lack all or some of the aforementioned protections.

The conversation 120 can also enable a set of user interactions (e.g., on a user interface) with the constituent messages 110. In a first example, a user can browse through the series of messages 110 by tapping the right (e.g., to skip to the next message) or the left (e.g., to replay the current message or play a prior message) of the screen of a user interface. In a second example, a user can pause and play a message 110 by tapping on a pause and/or play icon. In a third example, a visualization of the conversation 120 (e.g., the constituent messages 110) can be displayed. In an illustrative example, the series of messages 110 can be represented as a series of icons (e.g., lines), wherein the icon dimension (e.g., line length) can be proportional to the duration of the respective message 110, and the icon position in the series can correspond to the message position in the conversation 120; example shown in FIG. 9. The user can select a message 110 by selecting the icon (e.g., line) corresponding to the message 110. However, any other suitable set of interactions can be enabled.

The conversation 120 can be associated with a conversation identifier or not be associated with a conversation identifier. The conversation identifier can be generated based on: recording time (e.g., recording timestamp of the first message 110 within the conversation 120, etc.), the posting time (e.g., posting timestamp of the first message 110 within the conversation 120, etc.), user identifiers, message identifiers, messages 110, message content, room identifiers, topics, conversation permissions, and/or any other suitable information. The conversation identifier can be a hash, a concatenation of information, a string, and/or otherwise constructed. The conversation identifier can be globally unique, locally unique (e.g., within the room 130), nonunique, and/or otherwise unique or nonunique. The conversation identifier is preferably automatically determined, but can additionally and/or alternatively be manually determined, semi-automatically determined, and/or otherwise determined.

The conversation 120 can be associated with one or more pieces of metadata or not be associated with metadata. Examples of metadata associated with the conversation 120 can include: authors within the conversation 120 (e.g., users that recorded the constituent messages 110), number of authors, administrators (e.g., users controlling the permissions of the conversation 120), number of administrators, conversation's number of interactions (e.g., number of times users listened to the full conversation, number of times users started listening to the conversation, etc.), number of messages (e.g., current number of messages at a particular time), timestamp at which the first message 110 was added to the conversation 120, topics (e.g., topic tags), message identifiers (e.g., of constituent messages 110), conversation tiers, conversation permissions, information derived from metadata associated with the constituent messages 110 and/or metadata associated with the conversation's room 130, and/or any other suitable metadata.

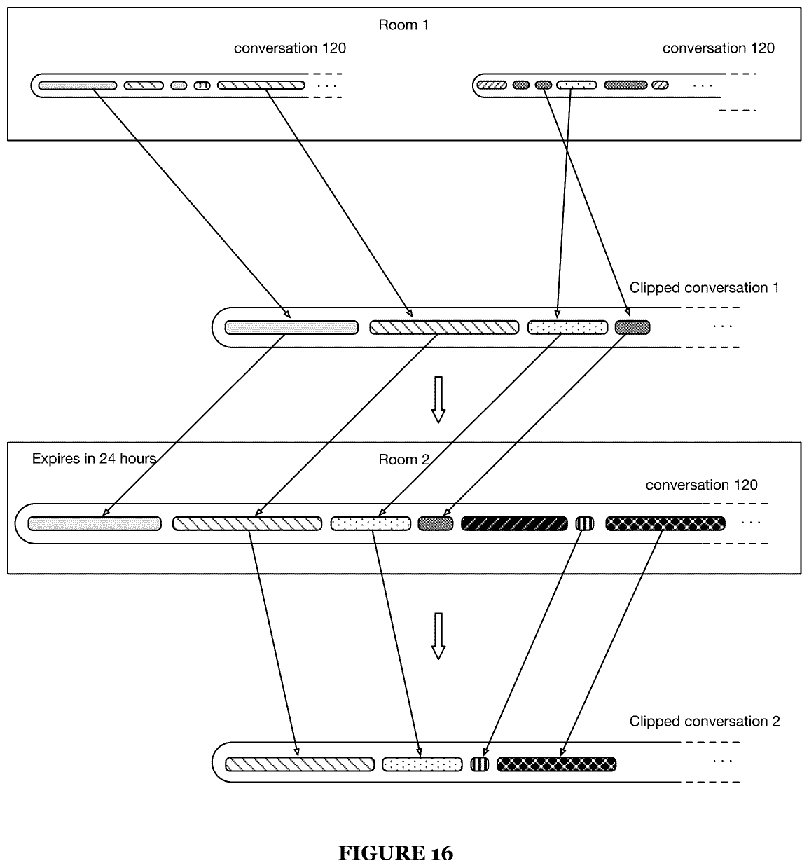

In variants, a conversation 120 (e.g., such as a clipped conversation) can be used to generate (e.g., “launch”) a new room 130; example shown in FIG. 16. Additionally and/or alternatively, the conversation 120 can be used to continue an existing conversation 120 in an existing room 130. However, the conversation 120 can be otherwise used.

However, the one or more conversations 120 can be otherwise configured.

The system 10 can include one or more rooms 130 (e.g., “production studios”, “chats”, virtual spaces, etc.), which can function as collections of one or more conversations 120. Each room 130 can include one or more conversations 120 or not include conversations 120. Different conversations 120 in a given room 130 can have different tiers, wherein different tiers can correspond to different sets of permissions (e.g., who can author messages 110 in the conversation 120, who can stitch messages 110 from the conversation and/or into the conversation 120, who can respond within the conversation 120, who can clip messages 110 from the conversation 120 and/or into the conversation, etc.), different playback settings (e.g., everyone can default to listening to a primary conversation 122 and must manually elect to listen to a secondary conversation 124), and/or otherwise differ.

In an illustrative example (e.g., example shown in FIG. 6), a room 130 can have a primary conversation 122 and secondary conversation 124, wherein a limited set of users (e.g., authors, forum speakers, lecturers, teachers, etc.) are authorized to contribute (e.g., author messages 110 within, stitch messages 110 from and/or into, clip messages 110 from and/or into, etc.) the primary conversation 122, while the remaining users (e.g., consumers, listeners, students, audience, etc.) have permissions to consume the primary conversation 122 (e.g., but not necessarily have permissions to contribute to the primary conversation 122). In this example, the authorized users can author messages 110 within the primary conversation 122, stitch messages 110 from other rooms 130 into the primary conversation 122 (and respond to the stitched-in messages), stitch messages 110 from the secondary conversation 124 into the primary conversation 122 (and respond to the stitched-in messages), and/or otherwise interact with the primary conversation 122. When a secondary message 110 from the secondary conversation 124 is stitched into the primary conversation 122, the author of the secondary message 110 preferably does not have permission to contribute to the primary conversation 122, but can alternatively be given permission to contribute to the primary conversation 122. The remaining users can respond to the primary conversation 122, wherein their messages 110 are added to the secondary conversation 124 (e.g., wherein their messages 110 identify a primary message from the primary conversation 122 as the parent message 112). The remaining users can also respond to the secondary conversation 124, wherein their messages 110 are also added to the secondary conversation 124 (e.g., and reference a secondary message from the secondary conversation 124 as the parent message 112).

In other illustrative examples, a room 130 can be limited to: only invited users, only invited users and other users directly connected to the invited users, only invited users and other users connected to the invited users to the second degree, all users, and/or otherwise impose user access limits.

The room 130 can be associated with a creation time (e.g., recording and/or posting time of the first message 110 within the first conversation 120 in the room 130; time specified by an administrator; etc.) or not be associated with a creation time. The room 130 is preferably non-persistent (e.g., temporary; be deleted from the system 10 and/or database 160 or unavailable after a predetermined threshold amount of time, such as 30 minutes, 1 hour, 1 day, 1 week, 1 month, etc.; etc.), but can additionally and/or alternatively be persistent. When the room 130 is non-persistent, the room 130 can be associated with an expiration time (e.g., expiration timestamp, expiration timeframe, expiration date, etc.) or not be associated with an expiration time.

The room 130 can be generated (e.g., “launched”, “created”, etc.) in response to a conversation 120 (e.g., adoptive conversation such as a clipped conversation), in response to a message 110, in response to a request (e.g., by a user), upon occurrence of a predetermined event, once, periodically, repeatedly, randomly, and/or at any other suitable time and/or frequency. For example, a new room 130 (e.g., a non-persistent room that expires after a threshold amount of time, such as 24 hours; a persistent room; etc.) is generated in response to a clipped conversation (e.g., a single-message clipped conversation, a multi-message clipped conversation, etc.). In this example, the new room 130 includes a new conversation 120 (e.g., new adoptive conversation), in which the new conversation 120 can include messages 110 from the clipped conversation 120. Multiple messages 110 from the new conversation 120 can be clipped into a second clipped conversation 120, in which the second clipped conversation 120 can be used to generate a second room 130; example shown in FIG. 16. However, the room 130 can be otherwise generated and/or used.

The room 130 can be associated with a room identifier or not be associated with a room identifier. The room identifier can be generated based on: recording time (e.g., recording timestamp of the first message 110 within the first conversation 120 of the room 130, etc.), posting time (e.g., posting timestamp of the first message 110 within the first conversation 120 of the room 130, etc.), user identifiers (e.g., of authors, of administrators, etc.), message identifiers, messages 110, message content, conversation identifiers, conversations 120, topics (e.g., topic tags), conversation tiers, conversation permissions, room name, and/or any other suitable information. The room identifier can be a hash, a concatenation of information, a string, and/or otherwise constructed. The room identifier can be globally unique, locally unique, nonunique, and/or otherwise unique or nonunique. The room identifier can be automatically determined, manually determined, and/or otherwise determined.

The room 130 can be associated with one or more pieces of metadata or not be associated with metadata. Examples of metadata associated with the room 130 can include: authors within the room 130 (e.g., users that recorded the constituent messages 110 for each conversation 120), number of authors within the room 130, consumers within the room 130 (e.g., users listening to the constituent messages 110 for each conversation 120), number of consumers within the room 130, room's number of interactions (e.g., number of times users listened to the full conversation 120 for each conversation 120), number of constituent conversations 120, conversation tiers, conversation permissions, information derived from metadata associated with constituent conversations 120 and/or metadata associated with constituent messages 110, and/or any other suitable metadata.

However, the one or more rooms 130 can be otherwise configured.

The system 10 can optionally include and/or be used with one or more models 140. The models 140 can be: local (e.g., executing on a user's device), remote, a third-party model, and/or be any other suitable model. The models 140 can be and/or include: neural networks (e.g., CNN, DNN, CV model, encoders, decoders, deep learning models, transformers, etc.), foundation models (e.g., GPT-3, BERT, DALL-E 2, SAM, etc.), generative algorithms (e.g., diffusion models, generative adversarial networks (GANs), variational autoencoders (VAEs), etc.), classification, rules, heuristics, an equation (e.g., weighted equations), regression (e.g., leverage regression), a curve, instance-based methods (e.g., nearest neighbor), regularization methods (e.g., ridge regression), decision trees, Bayesian methods (e.g., Naïve Bayes, Markov, etc.), kernel methods, statistical methods (e.g., probability), deterministics, support vectors, genetic programs, isolation forests, robust random cut forest, clustering, comparison models (e.g., vector comparison, image comparison, etc.), object detectors (e.g., CNN based algorithms, such as Region-CNN, fast RCNN, faster R-CNN, YOLO, SSD-Single Shot MultiBox Detector, R-FCN, etc.), feed forward networks, transformer networks, selection and/or retrieval (e.g., from a database 160 and/or library), any machine learning method, and/or any other suitable model or methodology. The models 140 can include (e.g., be constructed using) a set of input layers, output layers, and hidden layers (e.g., connected in series, such as in a feed forward network; connected with a feedback loop between the output and the input, such as in a recurrent neural network; etc.; wherein the layer weights can be learned through training); a set of fully or partially connected convolution layers (e.g., in a CNN); a set of self-attention layers; and/or have any other suitable architecture.

The models 140 can be trained (e.g. pre-trained) using: self-supervised learning, semi-supervised learning, supervised learning, unsupervised learning, reinforcement learning, transfer learning, Bayesian optimization, positive-unlabeled learning, using backpropagation methods (e.g., by propagating a loss calculated based on a comparison between the predicted and actual training target back to the model 140; by updating the architecture and/or weights of the model 140 based on the loss; etc.), and/or otherwise learned. The model 140 can be learned or trained on: labeled data (e.g., data labeled with the target label), unlabeled data, positive training sets (e.g., a set of data with true positive labels), negative training sets (e.g., a set of data with true negative labels), and/or any other suitable set of data.

The system 10 can include and/or be used with one or more related content models 142, one or more conversation models 144, and/or any other suitable models.

The one or more related content models 142 can function to determine related content 116 for one or more messages 110. However, the one or more related content models 142 can have any other suitable functionality. The system 10 can include one or more related content models 142 for: one or more users, one or more topics (e.g., topic tags), one or more timeframes, combinations thereof, and/or any other suitable parameters. Each related content model 142 can determine related content 116 for a single message 110, for multiple messages 110, and/or for any other suitable set of messages. Related content 116 can be determined using a single related content model 142, multiple related content models 142, and/or any other suitable number of related content models. Each related content model 142 can be specific to a user, a topic, a timeframe, and/or be otherwise specific. Additionally and/or alternatively, the related content model 142 can be generic across users, topics, timeframes, and/or be otherwise generic.

Inputs of each related content model 142, used to determine related content 116 for a message of interest, can include: one or more messages 110 (e.g., the a single message 110, a message 110 and the message's parent and/or child messages, the messages in a conversation, etc.), message identifiers, user identifiers, conversations 120, conversation identifiers, room identifiers, topics (e.g., topic tags), metadata (e.g., metadata associated with a message 110), and/or any other suitable inputs. The inputs can be associated with: a common time (e.g., a common timestamp, a common timeframe, etc.), different times, and/or be otherwise temporally related. Each related content model 142 can predict, extract, generate, and/or otherwise determine related content 116 for a message 110.

Outputs of each related content model 142 can include: text (e.g., transcription, translation, etc.), imagery, audio, video, haptic feedback, message identifiers, user identifiers, conversation identifiers, topics, and/or any other suitable outputs and/or related content 116.

In variants, the related content model 142 can be a generative model that generates the related content 116 (e.g., text, imagery, etc.) based on the message 110 as input. The generative model can be trained using training messages 110 associated with ground-truth related content 116 (e.g., provided by a user).

However, the one or more related content model 142 can be otherwise configured.

The one or more conversation models 144 can function to determine one or more conversations 120 (e.g., a series of messages 110) and/or the message order of messages 110 based on one or more messages 110. However, the one or more conversation models 144 can have any other suitable functionality. The system 10 can include one or more conversation models 144 for: one or more users, one or more user inputs (e.g., user preferences), one or more topics (e.g., topic tags), combinations thereof, and/or any other suitable parameters. The conversation model 144 preferably determines multiple conversations 120, but can additionally and/or alternatively determine a single conversation 120, and/or any other suitable number of conversations. A conversation 120 is preferably determined using a single conversation model 144, but can additionally and/or alternatively be determined using multiple conversation models 144, and/or any other suitable number of conversation models. The conversation model 144 can be specific to a user, a topic, a timeframe, a set of messages 110, a set of related content 116, and/or be otherwise specific. Additionally and/or alternatively, the conversation model 144 can be generic across users, topics, timeframes, messages 110, related content 116, and/or be otherwise generic.

Inputs of each conversation model 144, used to determine a conversation 120 for a set of messages 110 of interest, can include: messages 110, related content 116, message identifiers, user identifiers, conversation identifiers, room identifiers, topics (e.g., topic tags), metadata (e.g., metadata associated with a message 110), and/or any other suitable inputs. The inputs can be associated with: a common time (e.g., a common timestamp, a common timeframe, etc.), different times, and/or be otherwise temporally related. Each conversation model 144 can predict and/or otherwise determine a conversation 120.

Outputs of each conversation model 144 can include: one or more conversations 120, conversation identifiers, constituent messages 110, message identifiers, message order, metadata (e.g., metadata associated with constituent messages 110, metadata associated with a conversation 120, etc.), user identifiers, topics, and/or any other suitable outputs.

In variants, the conversation model 144 can be a set of heuristics that determines the message order for one or more messages 110. The set of heuristics can be learned, manually specified (e.g., by a user, by a different individual, etc.), and/or otherwise determined.

However, the one or more conversation models 144 can be otherwise configured.

However, the one or more models 140 can be otherwise configured.

The system 10 can include one or more computing systems 150, which can function to execute all or portions of the method, and/or perform any other suitable functionality. The computing system 150 is preferably a remote computing system (e.g., a platform, a server system, etc.), but can additionally and/or alternatively be performed by a distributed computing system, a local computing system (e.g., a user device such as mobile device, smartphone, smartwatch, tablet, laptop, desktop, etc.), a centralized computing system, a combination thereof, and/or be otherwise configured. The computing system 150 can optionally interface with the one or more databases 160. However, the one or more computing systems 150 can be otherwise configured.

The system 10 can optionally include one or more databases 160, which can function to store message data, conversation data, room data, metadata, and/or any other suitable information. The database 160 can be a remote database, a local database, a distributed database, a centralized database, a cloud database, a combination thereof, and/or be otherwise configured. The database 160 can be a NoSQL database, a relational database (RDS), a hierarchical database, and/or any other suitable database. The database 160 can be queryable (e.g., based on a user identifier, based on a message identifier, based on a conversation identifier, based on a room identifier, etc.) or not be queryable. However, the one or more databases 160 can be otherwise configured. However, the system 10 can include any other suitable components.

### 5. Method

The method can include: determining a set of messages S100, optionally generating related content based on the set of messages S200, determining a set of conversations based on the set of messages S300, and optionally providing the set of conversations S400. However, the method can be otherwise performed.

The method functions to determine a set of conversations 120 based on a set of messages 110.

One or more instances of the method can be performed for one or more users, one or more messages 110, one or more conversations 120, one or more rooms 130, one or more related content models 142, one or more conversation models 144, and/or otherwise performed.

All or portions of the method is preferably performed by the system 10 disclosed above (e.g., a remote system such as a platform), but can additionally and/or alternatively be performed by a local system, a third-party system, and/or any other suitable system.

All or portions of the method can be performed: in response to receiving a message 110, in response to receiving a request, upon occurrence of a predetermined event, once, periodically, repeatedly, randomly, continuously, and/or at any other suitable time and/or frequency.

The method can be iteratively performed for individual messages 110; be concurrently performed for multiple messages 110; and/or performed serially and/or in parallel for any other suitable number of messages.

However, the method can be otherwise performed.

### 5.1. Determining a Set of Messages S100.

Determining a set of messages S100 functions to receive asynchronous messages 110 recorded by users (e.g., authors) to be combined (e.g., in S200). However, S100 can have any other suitable functionality. S100 is preferably performed before S300, but can additionally and/or alternatively be performed concurrently with S200, after S200, and/or at any other suitable time. The set of messages 110 can include: one message 110, multiple messages 110, and/or any other suitable number of messages. Messages of the set 110 are preferably asynchronous, but can additionally and/or alternatively be synchronous, contemporaneous, concurrent, real-time, and/or otherwise temporally defined. Messages of the set 110 can be associated with the same conversation 120, different conversations 120, and/or not be associated with a conversation 120. Each message 110 (e.g., audio message) is preferably recorded internally by a user (e.g., by pressing and holding a record button during recording; by tapping the button to start recording and tapping the button again to stop recording; etc.), but can additionally and/or alternatively be recorded externally (e.g., in a recording studio), and/or otherwise recorded. The user recording the message 110 is preferably an author, but can additionally and/or alternatively be a consumer, an administrator, other users, and/or any other suitable individuals. The set of messages 110 can be received from one or more users, retrieved from a database 160, received from a third-party system, automatically generated, and/or otherwise determined.

In a first variant, S100 can include receiving a new message 110 from a user. In this variant, the user has recorded the message 110, optionally reviewed the message 110, optionally edited the message 110, optionally post-processed the message 110, optionally played back the message 110, and posted the message 110. However, the user can have any other suitable interaction with the message 110.

In a second variant, S100 can include retrieving a message 110 associated with a conversation 120 from a database 160.

In a third variant, S100 can include retrieving multiple messages 110 associated with one or more conversations 120 from a database 160. In this variant, when the multiple messages 110 are associated with multiple conversations 120, the multiple conversations 120 are preferably in the same room 130, but can additionally and/or alternatively be in different rooms 130.

However, the set of messages can be otherwise determined.

### 5.2. Generating Related Content Based on the Set of Messages S200.

Generating related content based on the set of messages S200 functions to generate related content 116 specific to the set of messages 110. However, S200 can have any other suitable functionality. S200 is preferably performed after S100, but can additionally and/or alternatively be performed concurrently with S100, concurrently with S300, after S300, before S400, and/or at any other suitable time. The related content 116 can include one piece of related content 116, multiple pieces of related content 116, and/or any other suitable number of pieces of related content 116. Examples of related content 116 can be: a transcription, a translation into another language (e.g., text or synthesized speech), imagery, audio, video, haptic feedback, and/or in any other suitable domain or modality. The related content 116 can be determined for each message 110 of the set of messages 110, determined for a batch of the set of messages 110, and/or otherwise determined. The related content 116 is preferably determined based on a set of messages 110 (e.g., the set of messages 110 determined in S100, different set of messages 110, etc.), but can additionally and/or alternatively be determined based on metadata associated with a message 110, user input (e.g., user preferences), and/or any other suitable information. The related content 116 can be automatically determined (e.g., generated using a related content model 142), manually determined, and/or otherwise determined.

In a first variant, a user can provide content (e.g., upload or link an image and/or video) as the related content 116, and record the audio/video message 110 over the provided content (e.g., voice over the content).

In a second variant, a (e.g., trained) related content model 142 (e.g., a neural network, a transformer, a foundation model, a generative model, etc.) can be used to generate the related content 116 based on the message 110. The related content model 142 can be: local (e.g., executing on the user's device), remote, a third-party model (e.g., OpenAI's GPT™, Google's Bard™, etc.), and/or be any other suitable model. In a first example, a first set of related content 116 is generated by one or more local related content models 142 based on the message 110 (e.g., audio/video message); a second set of related content 116 (e.g., higher-accuracy content) is generated by one or more remote related content models 142 based on the message 110 and optionally used to replace the first set of related content 116; and optionally a third set of related content 116 (e.g., even higher-accuracy content) is generated by a set of third-party related content models 142 based on the message 110, and optionally used to replace the second set of related content 116. In a second example, related content 116 for private messages 110 can be generated using local related content models 142 only, while related content 116 for public messages 110 can be generated using one or more of the local, remote, and/or third-party related content models 142. In a third example, related content 116 can be pre-generated and selected based on the message 110.

In a first illustrative example, visuals 116 (e.g., imagery) are generated from the message 110. For example, the visuals 116 can be directly generated from the message 110, or generated from a text intermediary (e.g., transcribed from the message 110) that is provided to a generative model 142.

In a second illustrative example, the message 110 (e.g., audio message) is transcribed into text 116 by passing the message 110 into a transcription model 142.

In a third illustrative example, the message 110 (e.g., audio/video message) is translated into another language by passing the message 110 into a multilingual translation model 142. For example, the audio/video message 110 can be transcribed, then translated into text in a second language; translated into audio in a second language (e.g., by directly translating and synthesizing the audio/video message 110 in the second language; by transcribing the audio/video message 110 to text, translating the text into a transcript in the second language, and synthesizing speech from the transcript; etc.); and/or otherwise translated into the second language.

In a fourth illustrative model, the audio/video message content can be fact checked by passing the audio/video message 110 (and/or a transcript thereof) to a fact-checking model 142 (e.g., ChatGPT™, Bard™, etc.). The fact-checked results can be indicated in the related content 116 (e.g., as a badge, star, etc.), can appear within the related content 116 (e.g., the related content 116 is edited or augmented with the fact-checked results), can be used to edit the audio/video message 110 itself, and/or be otherwise used.

However, the related content 116 can be otherwise determined using a related content model 142.

However, the related content can be otherwise generated.

### 5.3. Determining a Set of Conversations Based on the Set of Messages S300.

Determining a set of conversations based on the set of messages S300 functions to determine a set of conversations 120 (e.g., original conversation, adoptive conversation, clipped conversation, etc.) based on the set of messages 110, wherein each conversation 120 includes a series of messages 110. Determining a conversation can include: creating a conversation (e.g., clipping messages into a conversation, stitching messages into a pre-existing conversation, etc.), retrieving a pre-existing conversation, and/or otherwise determining a conversation. However, S300 can have any other suitable functionality. S300 is preferably performed after S100, but can additionally and/or alternatively be performed concurrently with S100, concurrently with S200, before S400, and/or at any other suitable time. The set of conversations 120 can include one conversation 120, multiple conversations 120, and/or any other suitable number of conversations 120. Examples of conversations 120 can include: original conversations (e.g., conversation 120 that the message 110 was authored and/or posted within), adoptive conversations (e.g., conversation 120 that the message 110 was not originally authored and/or posted within, but is subsequently added to after posting to the original conversation), and/or any other suitable conversations 120. Each conversation 120 can be associated with a conversation tier or not be associated with a conversation tier. Examples of conversation tiers can include: primary conversations, secondary conversations, tertiary conversations, and/or any other suitable conversation tiers. The set of conversations 120 can be within the same room 130, different rooms 130, and/or otherwise configured. The set of conversations 120 is preferably determined based on a set of messages 110 (e.g., the set of messages 110 determined in S100, different set of messages 110, etc.), but can additionally and/or alternatively be determined based on metadata associated with each message 110, related content 116 associated with each message 110, user input (e.g., user preferences), and/or any other suitable information. The set of conversations 120 is preferably automatically determined (e.g., determined using a conversation model 144), but can additionally and/or alternatively be manually determined (e.g., by a user), and/or otherwise determined.

In a first variant, S300 can include adding a new message 110 (e.g., received from a user) into a conversation 120. The new message 110 can be associated with a parent message 112 (e.g., a prior message in a conversation 120 that the new message 110 is responding to) or not be associated with a parent message 112 (e.g., be the beginning of a conversation 120). The conversation 120 can be an original conversation (e.g., relative to the parent message 112 of the new message 110), an adoptive conversation (e.g., relative to the parent message 112 of the new message 110), and/or any other suitable conversation. The new message 110 is preferably appended into the conversation 120 based on recordation and/or posting order (e.g., recordation and/or posting order compared to the constituent messages 110 in the conversation 120), but can additionally and/or alternatively be appended into the conversation 120 based on dependency order (e.g., wherein the new message 110 is arranged proximal to the parent message 112), appended into the conversation 120 based on message content similarity, randomly appended, and/or otherwise appended. The message order for the new message 110 can be predetermined, determined automatically (e.g., using a conversation model 144), but can additionally and/or alternatively be manually determined, and/or otherwise determined. The new message 110 can be added to the end of the conversation 120 (e.g., appended onto the conversation), inserted into the body of the conversation (e.g., between existing messages in the conversation), and/or added to any other suitable position within the conversation. The new message 110 can be added in the same position in a given conversation for all users or a subset of users (e.g., added to a first conversation position for all users that have not consumed the conversation past the first conversation position and added to a second conversation position for all users that have consumed the conversation past the first conversation position, etc.), be added to different conversation positions for different users, and/or be added to any other suitable conversation position.

In a first embodiment, the new message 110 is appended to the end of the conversation 120, wherein the new message 110 is recorded and/or posted most recently compared to existing constituent messages 110 in the conversation 120.

In a second embodiment, the new message 110 is appended to the conversation 120 using a conversation model 144 (e.g., a neural network, a set of heuristics and/or rules, etc.). In a first example, the conversation model 144 includes a set of heuristics that determines the message order for the new message 110. In an illustrative example of the first example, the new message 110 is appended to the end of the conversation 120 if a user (e.g., consumer) has already passed the parent message 112 or is appended to after the parent message 112 if the user has not already passed the parent message 112. In a second example, the conversation model 144 is a neural network that receives the new message 110 and the conversation 120 as inputs and outputs a final conversation 120 that includes the appended message 110. However, the new message 110 can be otherwise appended to the conversation 120 using a conversation model 144.

In a third embodiment, the message order for the new message 110 is specified by a user, wherein the new message 110 is appended to the conversation 120 based on the specified message order.

However, the new message 110 can be otherwise appended into a conversation 120.

In a second variant, S300 can include stitching a message 110 (e.g., retrieved from a database 160) from a conversation 120 (e.g., first conversation, originating conversation, etc.) into an adoptive conversation 120 (e.g., a conversation 120 that the message 110 was not originally posted within, but is subsequently added to after posting to the original conversation 120 and/or a different adoptive conversation 120). The message 110 can be an original message 110 (e.g., originally posted in the conversation 120) or be a stitched message 110 (e.g., not originally posted in the conversation 120). The message 110 is preferably a copy of the message 110 from the conversation 120, but can additionally and/or alternatively be the message 110 itself from the conversation 120, and/or any other suitable message 110. The conversation 120 and the adoptive conversation 120 are preferably in different rooms 130, but can additionally and/or alternatively be in the same room 130. The conversation 120 the message 110 is stitched from is preferably an original conversation 120 (e.g., a conversation 120 that the message 110 was originally posted within), but can additionally and/or alternatively be an adoptive conversation 120, and/or any other suitable conversation 120. The message 110 is preferably stitched from a conversation 120 into an adoptive conversation 120 based on a stitching reference (e.g., references the message 110 in the adoptive conversation 120), but can additionally and/or alternatively be stitched from a conversation 120 into an adoptive conversation 120 based on metadata associated with a message 110 (e.g., message content), message identifiers, and/or any other suitable information. The stitching reference can be automatically assigned (e.g., using a conversation model 144), manually assigned (e.g., by a user), and/or otherwise determined. In an illustrative example of the second variant, stitching a message 110 from a conversation 120 into an adoptive conversation 120 includes: stitching a copy of a book review message 110 from an original conversation 120 in a first book review room 130 into an adoptive conversation 120 in a second book review room 130. However, the message 110 can be otherwise stitched.

In third variant, S300 can include clipping multiple messages 110 (e.g., retrieved from a database 160) from a set of conversations 120 into a clipped conversation 120 (e.g., assembled sub-conversation of the multiple messages 110); example shown in FIG. 14. The set of conversations can include one or more conversations. The multiple messages 110 are preferably copies of the messages 110 from the set of conversations 120, but can additionally and/or alternatively be the messages 110 themselves from the set of conversations 120, be a pointer to the message 110 in the conversation 120 (e.g., originating conversation, adoptive conversation, etc.), and/or be any other suitable messages 110. The multiple messages 110 are preferably public messages 110, but can additionally and/or alternatively be private messages 110, and/or be associated with any other suitable permissions. The clipped conversation 120 is preferably a subset conversation 120 of the set of conversations 120, but can additionally and/or alternatively be a superset conversation 120 of the set of conversations 120. The multiple messages 110 are preferably determined manually (e.g., a user selecting individual messages 110 that will be clipped into the clipped conversation 120), but can additionally and/or alternatively be determined automatically (e.g., using a conversation model 144). The clipped conversation 120 can optionally include new messages 110 in addition to the clipped messages (e.g., messages recorded by a clipped conversation author, etc.). The clipped multiple messages 110 in the clipped conversation 120 are preferably organized in recordation and/or posting order, but can additionally and/or alternatively be organized in dependency order, organized based on message content similarity, randomly organized, manually organized, and/or otherwise organized. The clipped messages are preferably unedited (e.g., as originally posted) and/or uneditable (e.g., preserves its atomicity), but can additionally or alternatively have one or more edited parameters. Examples of message parameters that can be edited can include: playback speed, duration, volume, background noise, pitch, overlays, transcript, content, voice, and/or other parameters; alternatively, one or more message parameters (e.g., content, voice, etc.) can be precluded from editing (e.g., locked by default, locked by the platform, locked by the message author, etc.). In an illustrative example, the clipped message can be cut or otherwise edited. However, the multiple messages 110 can be otherwise clipped.

In a fourth variant, S300 can include providing a set of messages 110 to a user on a user interface, and receiving a set of conversations 120 specified by the user.

In a fifth variant, S300 can include randomly combining a set of messages 110 into a set of conversations 120.

However, the set of conversations can be otherwise determined.

### 5.4. Providing the Set of Conversations S400.

Providing the set of conversations S400 functions to provide the set of conversations 120 (e.g., original conversation, adoptive conversation, clipped conversation, etc.) to an endpoint through an interface. However, S400 can have any other suitable functionality. S400 is preferably performed after S300, but can additionally and/or alternatively be performed concurrently with S300, after S200, after S100, and/or at any other suitable time. The set of conversations 120 can include: one conversation 120, multiple conversations 120, and/or any other suitable number of conversations. The set of conversations 120 is preferably the set of conversations 120 determined in S300, but can additionally and/or alternatively be any other suitable conversations 120. Examples of conversations that can be presented include: the original conversations, the adoptive conversations, the clipped conversations, a combination thereof, and/or any other suitable conversation. The endpoint can be: a user endpoint, a user interface, a third-party application and/or system (e.g., messaging application, native user device applications, social media applications, Facebook™, Instagram™, TikTok™, WhatsApp™, WeChat™, Twitter™, LinkedIn™, YouTube™, LinkedIn™, Messenger™, etc.), and/or any other suitable endpoint. The interface can be on a mobile application, a smartphone application, a native application, a web application, a desktop application, an API, and/or any other suitable interface executing on a user device (e.g., mobile device, smartphone, smartwatch, etc.), gateway, and/or any other suitable computing system.

In a first variant, S400 can include providing the set of conversations 120 to a user interface (e.g., mobile application, smartphone application, etc.) executing on a user device (e.g., mobile device, smartphone, etc.). In a first embodiment of the first variant, a conversation 120 can be played back (e.g., a series of constituent messages 110 played back) and the related content 116 associated with the constituent messages 110 of the conversation 120 can be optionally presented (e.g., played back, displayed on the user interface, etc.). For each related content 116 associated with a constituent message 110, the related content 116 is preferably presented concurrently with constituent message playback (e.g., overlaid over the audio/video message 110), but can additionally and/or alternatively be presented asynchronously from constituent message playback (e.g., as a text summary of the conversation 120, etc.). However, the conversation 120 can be otherwise played back. In a second embodiment of the first variant, a conversation 120 (e.g., a clipped conversation 120) can be saved to the user device.

In a second variant, S400 can include providing the set of conversations 120 to a third-party application and/or system (e.g., using a third-party API integration). In this variant, a conversation 120 can be exported and/or shared to a third-party application and/or system. For example, a conversation 120 (e.g., a clipped conversation 120) is exported to and shared on a social media application (e.g., Instagram™, TikTok™, etc.).

However, the set of conversations can be otherwise provided.

S400 can optionally include converting the set of conversations 120 into a file in an exportable format, wherein the file can be provided to an endpoint through an interface. Examples of exportable formats can include: MP3, MP4, M4A, AAC, WAV, AIFF, FLAC, WMV, MKV, and/or any other suitable audio and/or video file formats. The exportable format can be determined automatically (e.g., based on which third-party application and/or system the file is exported to), manually (e.g., specified by a user), and/or otherwise determined.

S400 can optionally include reducing the size of the file (e.g., compressing the file), wherein reduced size file can be provided to an endpoint through an interface. The reduced size can be determined automatically (e.g., based on which social media platform the file is exported to), manually (e.g., specified by a user), and/or otherwise determined.

However, the method can be otherwise performed.

All or portions of the system and/or method can be executed in real time (e.g., responsive to a request), iteratively, concurrently, asynchronously, periodically, and/or at any other suitable time. All or portions of the method can be performed automatically, manually, semi-automatically, and/or otherwise performed.

All or portions of the system can be executed by one or more components of the system, using a computing system, by a user, and/or by any other suitable system. The computing system can be local, remote, distributed, or otherwise arranged relative to any other system or module.

All references cited herein are incorporated by reference in their entirety, except to the extent that the incorporated material is inconsistent with the express disclosure herein, in which case the language in this disclosure controls.

Different subsystems and/or modules discussed above can be operated and controlled by the same or different entities. In the latter variants, different subsystems can communicate via: APIs (e.g., using API requests and responses, API keys, etc.), requests, and/or other communication channels. Communications between systems can be encrypted (e.g., using symmetric or asymmetric keys), signed, and/or otherwise authenticated or authorized.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

1. A communication system, comprising:
a set of originating conversations, wherein each originating conversation comprises a set of asynchronously-recorded, non-overlapping audio messages recorded by a set of authors, wherein each message in the set of asynchronously-recorded, nonoverlapping audio messages is atomic and uneditable after posting, and comprises a dependency on a parent message within the originating conversation; and
a set of adoptive conversations, wherein each adoptive conversation comprises a subset of the messages from the set of originating conversations, wherein each message in the subset of the messages maintains atomicity and the respective dependency, wherein each message in the subset of the messages from the set of originating conversations remains uneditable when added to the adoptive conversation.

2. The system of claim 1, wherein the set of originating conversations comprises a primary conversation and a secondary conversation within a same virtual room, wherein a message from the secondary conversation is stitched into the primary conversation.

3. The system of claim 2, wherein a limited set of users are authorized to author messages in the primary conversation, wherein an unlimited set of users are authorized to author messages in the secondary conversation, and wherein an author of the message from the secondary conversation is not authorized to contribute to the primary conversation after the message is stitched into the primary conversation.

4. The system of claim 1, wherein a new message is appended to an originating conversation of the set of originating conversations based on recordation order and independent of parent message dependency.

5. The system of claim 1, wherein a message from the set of originating conversations is appended into an adoptive conversation from the set of adoptive conversations based on recordation order.

6. The system of claim 5, wherein new messages recorded within the adoptive conversation comprise a dependency on the message from the set of originating conversations.

7. The system of claim 1, wherein a message is dependent on a parent message when the message is recorded within a predetermined time period after playback of the parent message or when the message is recorded during playback of the parent message.

8. The system of claim 1, wherein a new message is appended to an end of the originating conversation when a consumer has already passed the parent message, and is appended after the parent message when the consumer has not already passed the parent message.

9. The system of claim 1, wherein the subset of the messages are selected by a user on an interface.

10. The system of claim 1, wherein a message from the set of originating conversations is associated with related content comprising at least one of a text transcription of the message or a text translation of the message.

11. The system of claim 10, wherein the related content is presented concurrently with playback of the message.

12. The system of claim 10, wherein the related content is generated using a local model when the message is a private message and generated using a remote model when the message is a public message.

13. The system of claim 1, wherein an adoptive conversation of the set of adoptive conversations is exported to a third-party system.

14. The system of claim 1, wherein a message of an originating conversation is recorded during a continuous button press.

15.-20. (canceled)

21. A communication system, comprising:
a set of originating conversations, wherein each originating conversation comprises a set of asynchronously-recorded, non-overlapping audio messages recorded by a set of authors, wherein each message in the set of asynchronously-recorded, nonoverlapping audio messages is atomic and uneditable after posting; and
a set of adoptive conversations, wherein each adoptive conversation comprises at least a message from an originating conversation from the set of originating conversations or from a different adoptive conversation, wherein the message maintains atomicity, wherein the message from the originating conversation remains uneditable when added to the adoptive conversation.

22. The system of claim 21, wherein the set of authors comprises two authors.

23. The system of claim 21, wherein each adoptive conversation of the set of adoptive conversations is associated with two authors.

24. The system of claim 21, wherein messages from an originating conversation or an adoptive conversation are associated with related content comprising at least one of text transcription or text translation.

25. The system of claim 24, wherein the related content is displayed on an interface.

26. The system of claim 24, wherein the related content is generated using a model based on the messages.
